(19) United States
(12) Patent Application Publication
(10) Pub. No.: US 2026/0326517 A1
(43) Pub. Date: Oct. 22, 2026

(54) IN-VEHICLE SUN VISOR EXTENDER

(71) Applicant: Shenzhen Glamortech Industrial Co., Ltd, Shenzhen (CN)

(72) Inventor: PENGBO MU, Huizhou (CN)

(21) Appl. No.: 19/695,306

(22) Filed: Jun. 2, 2026

(30) Foreign Application Priority Data
Aug. 13, 2025 (CN) 202511128142.0

(51) Int. Cl. B60J 3/02

(52) U.S. Cl. CPC B60J 3/023; B60J 3/0239

(57) ABSTRACT

An in-vehicle sun visor extender, including a sun shading sheet, a bracket main body, and a clamping member slidably connected to the bracket main body. The clamping member includes a rotating shaft assembly and a locking member which can lock a relative position between the bracket main body and the clamping member. The sun shading sheet is fixedly connected to the bracket main body. The locking member is arranged on the clamping member slidably connected to the bracket main body, so that the in-vehicle sun visor extender has high stability in a use state. In addition, the locking member cooperates with a sliding rail, so that the in-vehicle sun visor extender has a simple structure, is convenient to operate and adjust, and will not block a makeup mirror.

### TECHNICAL FIELD

The present disclosure relates to the technical field of vehicles, and specifically, to an in-vehicle sun visor extender.

### BACKGROUND

The automobile ownership keeps increasing. A user needs to use an automobile in different environments when going out, such as in a morning glare scenario, in a sunset glare scenario, and under a post-snow condition. A factory-fitted sun visor still cannot solve the problems of direct sunlight and snow reflection. Therefore, there is a requirement for an in-vehicle sun visor extender.

### SUMMARY

In view of this, for the foregoing drawbacks and problems, an embodiment of the present disclosure provides an in-vehicle sun visor extender. A user can freely adjust a position and angle of the in-vehicle sun visor extender based on a direction of a light source, while implementing high stability.

To achieve the foregoing objectives, the present disclosure adopts the following technical solution:

An in-vehicle sun visor extender includes a sun shading sheet, a bracket main body, and a clamping member slidably connected to the bracket main body.

The clamping member includes a rotating shaft assembly and a locking member. The locking member is able to lock a relative position between the bracket main body and the clamping member.

The sun shading sheet is fixedly connected to the bracket main body.

Further, the bracket main body includes a sliding rail, and the clamping member is slidably connected to the bracket main body through the sliding rail.

Still further, a cross section of the sliding rail is substantially C-shaped. The locking member includes a T-shaped structure. The T-shaped structure includes a horizontal portion and a vertical portion. The locking member is slidably connected to the sliding rail through the horizontal portion.

Still further, the locking member further includes a clamping handle, and the clamping member is rotatably connected to the clamping handle through the vertical portion.

Still further, the rotating shaft assembly includes a fitting portion, a rotating shaft, and a connection portion. The fitting portion is rotatably connected to the connection portion through the rotating shaft. The fitting portion is provided with an opening. The vertical portion passes through the opening and is rotatably connected to the clamping handle.

Still further, the fitting portion is fitted with a surface of the sliding rail.

Further, the clamping member includes an elastic clip, and the elastic clip is fixedly connected to the connection portion.

Further, the clamping handle includes a plurality of cams arranged in sequence, and heights of the plurality of cams are different.

Further, one or more clamping members are provided.

Further, one or more sliding rails are provided.

Beneficial effects of the embodiments of the present disclosure are as follows:

In the present disclosure, the locking member is arranged on the clamping member slidably connected to the bracket main body, so that the in-vehicle sun visor extender has high stability in a use state. In a driving process of an automobile, in a vibration test, the bracket main body and the clamping member do not have a relative displacement.

In addition, the locking member cooperates with the sliding rail, so that the in-vehicle sun visor extender has a simple structure, and is convenient to operate and adjust. Locking can be completed by opening a locking structure, adjusting the position of the clamping member, and closing the locking structure.

Finally, the clamping member is slidably connected to the bracket main body and is provided with the rotating shaft assembly, so that the in-vehicle sun visor extender will not block a makeup mirror. Furthermore, an angle of the extender can be adjusted until the extender is perpendicular to the line of sight, which is more convenient and safer.

### BRIEF DESCRIPTION OF THE DRAWINGS

For clearer descriptions of the technical solutions of the embodiments of the present disclosure, the drawings required to be used in the embodiments are briefly introduced below. It should be understood that the drawings below are only some embodiments of the present disclosure. Therefore, the embodiments shall not be regarded as limitations on the scope. A person of ordinary skill in the art can also obtain other relevant drawings according to these drawings without creative work.

FIG. 1 is an exploded diagram of a structure of an in-vehicle sun visor extender provided in an embodiment of the present disclosure;

FIG. 2 is a schematic diagram of an entire structure of an in-vehicle sun visor extender provided in an embodiment of the present disclosure;

FIG. 3 is a schematic diagram of a structure of a sun shading sheet provided in an embodiment of the present disclosure;

FIG. 4 is a top view of a structure of a bracket main body provided in an embodiment of the present disclosure;

FIG. 5 is a side view of a structure of a bracket main body provided in an embodiment of the present disclosure;

FIG. 6 is a cross-sectional view of a sliding rail provided in an embodiment of the present disclosure;

FIG. 7 is a schematic diagram of a structure of a rotating shaft assembly provided in an embodiment of the present disclosure;

FIG. 8 is a schematic diagram of a structure of a T-shaped structure provided in an embodiment of the present disclosure;

FIG. 9 is a schematic diagram of a structure of a clamping handle provided in an embodiment of the present disclosure;

FIG. 10 is a schematic diagram of a structure of an elastic clip provided in an embodiment of the present disclosure;

FIG. 11 is a schematic diagram of a structure of an upper rotating shaft cover provided in an embodiment of the present disclosure; and

FIG. 12 is a schematic diagram of a structure of a lower rotating shaft cover provided in an embodiment of the present disclosure.

Reference numerals in the drawings:
1: sun shading sheet; 101: sun shading sheet fixing hole; 102: sun shading sheet edge;
2: bracket main body; 201: bracket main body fixing hole; 202: sun shading sheet mounting slot; 203: sliding rail mounting portion; 204: fixing hole;
3: sliding rail; 303: sliding rail mounting hole; 304: sliding rail fixing hole; 305: T-shaped slot; 306: T-shaped slot inner surface; 308: sliding rail surface;
4: rotating shaft assembly; 405: opening; 407: connection portion; 408: fitting portion; 409: connection hole; 4010: rotating shaft;
5: T-shaped structure; 505: vertical portion; 506: horizontal portion; 5011: T-shaped structure rotating shaft hole;
6: clamping handle; 605: open slot; 6011: clamping handle rotating shaft hole; 6012: cam; 6013: manual push portion; 6014: handle body;
7: elastic clip; 709: elastic clip connection hole; 7015: clip body;
8: upper rotating shaft cover; 805: upper cover opening; 8014: upper cover fitting portion;
9: lower rotating shaft cover; 909: lower cover connection hole; and 9010: rotating shaft clearance hole.

### DETAILED DESCRIPTION OF THE EMBODIMENTS

In order to make the objectives, technical solutions, and advantages of the embodiments of the present disclosure clearer, the technical solutions in the embodiments of the present disclosure are clearly and completely described below with reference to the accompanying drawings in the embodiments of the present disclosure. Apparently, the described embodiments are merely some rather than all of the embodiments of the present disclosure. Assemblies of the embodiments of the present disclosure commonly described and shown in the accompanying drawings here may be arranged and designed in a variety of different configurations.

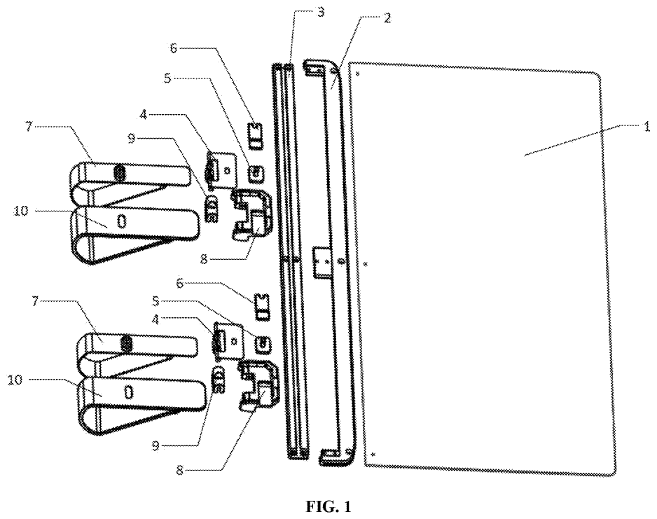

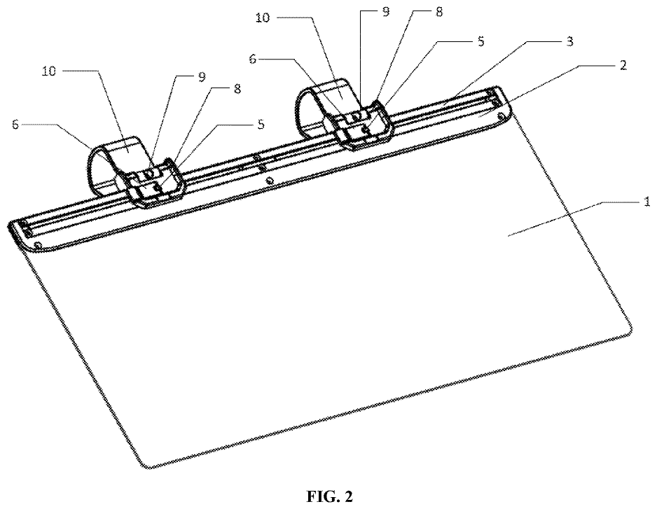

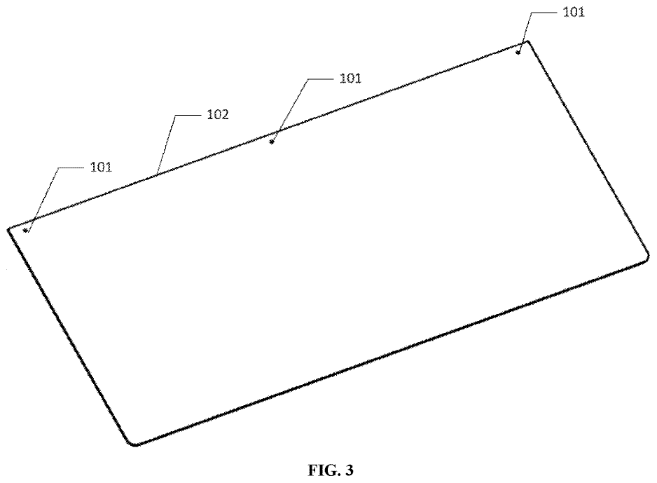

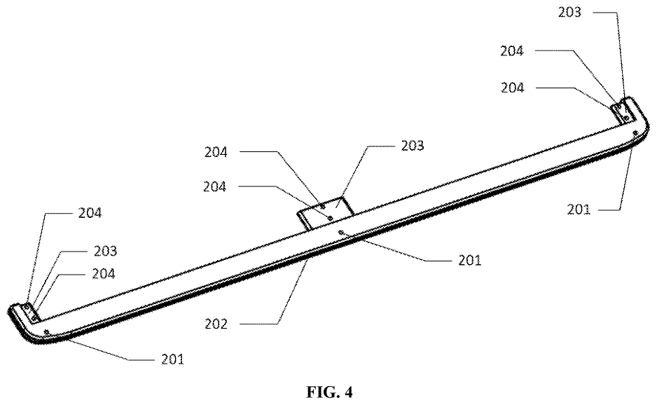

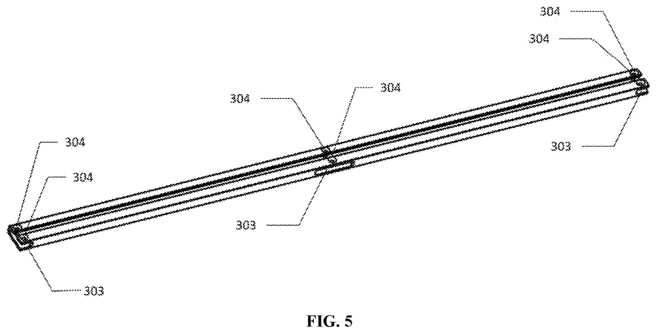

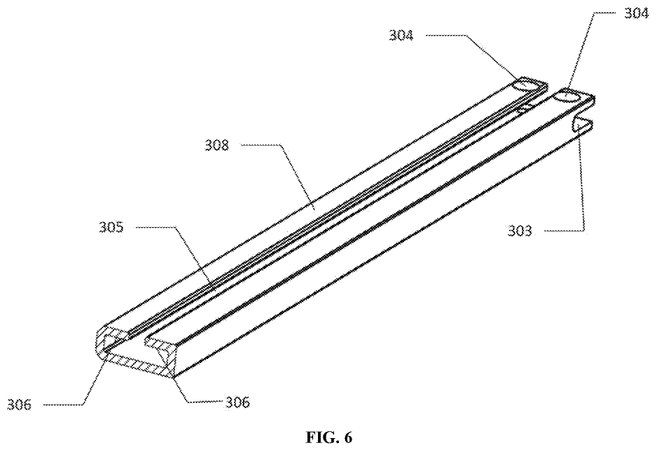

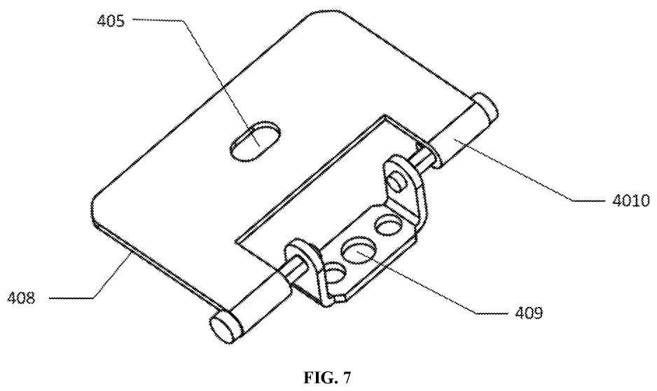

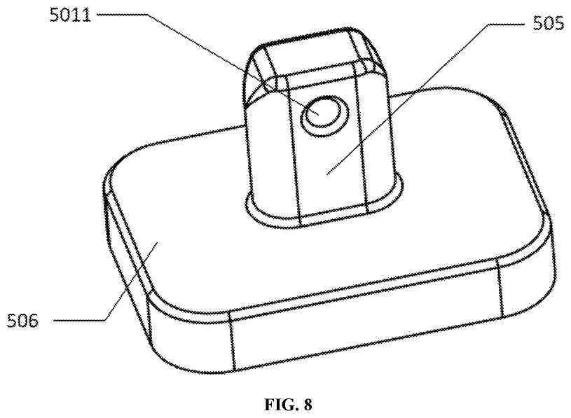

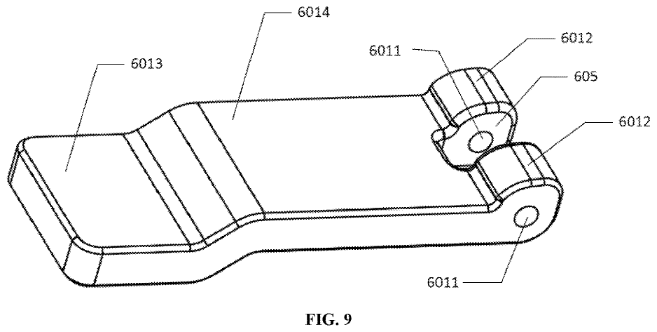

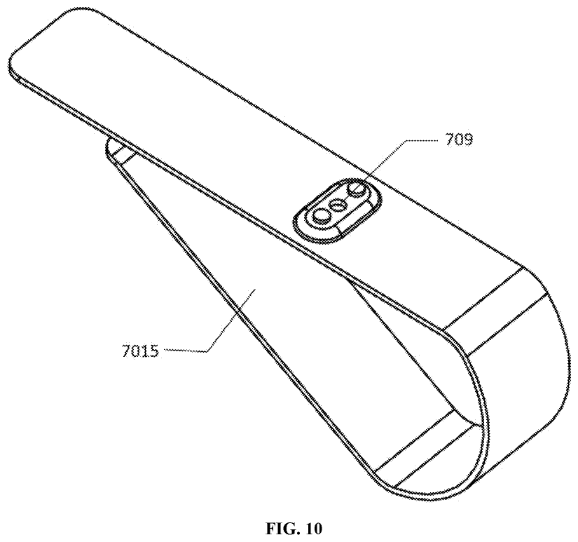

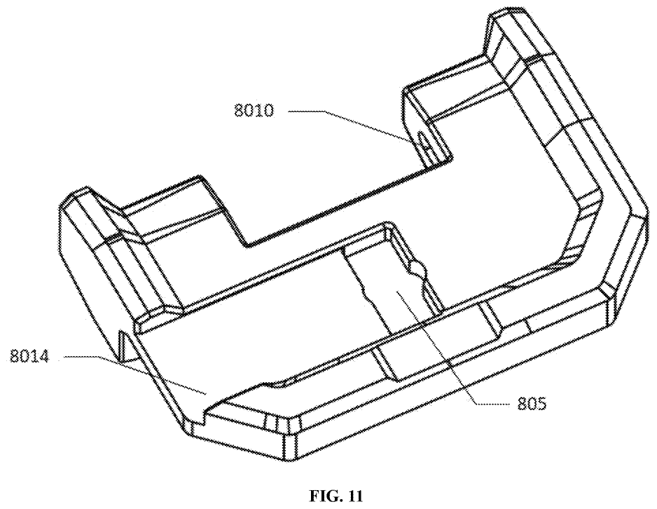

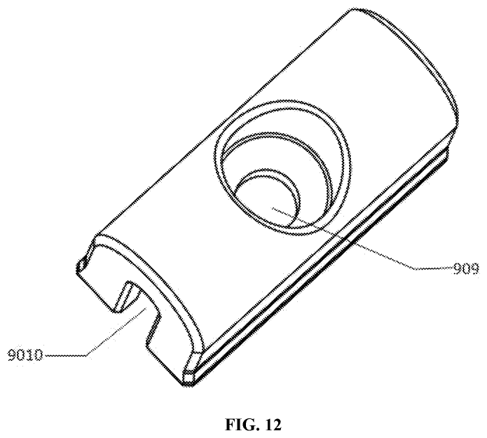

Referring to FIG. 1 to FIG. 12, an embodiment of the present disclosure provides an in-vehicle sun visor extender, including a sun shading sheet 1, a bracket main body 2, and a clamping member. The clamping member includes a rotating shaft assembly 4 and a locking member. The locking member can lock a relative position between the bracket main body 2 and the clamping member.

In one embodiment, the bracket main body 2 is provided with a sun shading sheet mounting slot 202. The sun shading sheet edge 102 can be inserted into the sun shading sheet mounting slot 202 and is fixedly connected via a main body fixing hole 201 and a sun shading sheet fixing hole 101. The bracket main body 2 can also play a role in fixing the sun shading sheet 1 and enhancing the strength of the sun shading sheet 1.

In one embodiment, the bracket main body 2 is provided with a sliding rail mounting portion 203, and correspondingly, the sliding rail 3 is provided with a sliding rail mounting hole 303. In addition, the sliding rail mounting portion 203 is provided with a fixing hole 204, while the sliding rail 3 is provided with a sliding rail fixing hole 304. The sliding rail mounting portion 203 passes through the sliding rail fixing hole 303 and is fixedly connected via the fixing hole 204 and the sliding rail fixing hole 304. For example, a screw passes through the fixing hole 204 and the sliding rail fixing hole 304 to achieve fixed connection. The sliding rail 3 is made of a metal material, which can enhance the strength of the bracket main body 2.

In one embodiment, a cross section of the sliding rail 3 is substantially C-shaped, thereby forming a T-shaped slot 305 inside the sliding rail 3. Correspondingly, the locking member 3 can include a T-shaped structure 5. A vertical portion 505 of the T-shaped structure 5 extends out from an opening portion of the T-shaped slot. A horizontal portion 506 of the T-shaped structure 5 is stuck by the opening portion of the T-shaped slot 305 in a vertical direction, but can slide in a horizontal direction, so that the locking member can be slidably connected to the sliding rail 3, without being detached from the sliding rail 3, namely, the clamping member is slidably connected to the sliding rail 3.

It can be understood that one surface, connected to the vertical portion 505, of the horizontal portion 506 of the T-shaped structure 5 can be fitted with a T-shaped slot inner surface 306 of the sliding rail 3.

In one embodiment, the locking member further includes a clamping handle 6. An open slot 605 is formed in one end of the clamping handle 6. Within the open slot 605, the vertical portion 505 of the T-shaped structure 5 can be rotatably connected to the clamping handle 6 through a pin. Specifically, the clamping handle 6 is provided with a clamping handle rotating shaft hole 6011 in one end of the open slot 605, and the vertical portion 505 is provided with a T-shaped structure rotating shaft hole 5011. A pin simultaneously passes through both the clamping handle rotating shaft hole 6011 and the T-shaped structure rotating shaft hole 5011, to implement rotatable connection between the T-shaped structure 5 and the clamping handle 6. The clamping handle 6 can rotate 0 to 90 degrees by using the pin as a center, namely, the clamping member is rotatably connected to the clamping handle 6.

In one embodiment, the rotating shaft assembly 4 includes a connection portion 407, a fitting portion 408, and a rotating shaft 4010. The fitting portion 408 is rotatably connected to the connection portion 407 through the rotating shaft 4010. The fitting portion 408 is configured as a flat surface and is provided with an opening 405. The vertical portion 505 of the T-shaped structure 5 passes through the opening 405 and is rotatably connected to the clamping handle 6. The T-shaped structure 5, the fitting portion 408, and the clamping handle 6 are sequentially arranged to achieve fitting of the fitting portion 408 and a sliding rail surface 308.

In one embodiment, the elastic clip 7 is provided with an elastic clip connection hole 709. The connection portion 407 is provided with a connection hole 409. The elastic clip 7 and the rotating shaft assembly 4 are fixedly connected to each other through the elastic clip connection hole 709 and the connection hole 409. For example, a screw passes through the elastic clip connection hole 709 and the connection hole 409 to achieve the fixed connection. A clip body 7015 of the elastic clip 7 is elastic and can clamp a factory-fitted sun visor of an automobile.

In one embodiment, the in-vehicle sun visor extender can further include a protective member, such as an upper rotating shaft cover 8, a lower rotating shaft cover 9, and an elastic clip leather sleeve 10. The upper rotating shaft cover 8 is provided with an upper cover opening 805. The vertical portion 505 of the T-shaped structure 5 can pass through the upper cover opening 505 and be rotatably connected to a clamping handle rotating shaft hole 6011 of the clamping handle 6.

Further, a manual push portion 6013 is arranged at one end of the clamping handle 6 away from the open slot 605. The manual push portion 6013 and a handle body 6014 are arranged in a stepped manner. When the locking member is in a locked state, the handle body 6014 is fitted with an upper cover fitting portion 8014 of the upper rotating shaft cover 8. In this state, the manual push portion 6013 facilitates opening of the clamping handle by a user.

Further, the lower rotating shaft cover 9 is provided with a lower cover connection hole 909. A screw is used to sequentially pass through the lower cover connection hole 909, the elastic clip mounting hole 709, and the mounting hole 409, to fixedly connect the elastic clip 7 to the connection portion 407 of the rotating shaft assembly 4. In addition, the lower rotating shaft cover 9 is provided with a rotating shaft clearance hole 9010 configured to avoid the rotating shaft 4010 of the rotating shaft assembly 4.

In one embodiment, the locking member includes a clamping handle 6 and a T-shaped structure 5. A horizontal portion 505 of the T-shaped structure 5 can slide within the T-shaped slot 305 of the sliding rail 3. A plurality of cams 6012 with different heights are sequentially arranged at one end of an open slot 605 of the clamping handle 6. By pushing the manual push portion 6013, a user can drive different surfaces of the cams 6012 to be fitted with the fitting portion 408 of the rotating shaft assembly 4, thereby adjusting a gap among the T-shaped structure 5, the sliding rail 3, the rotating shaft assembly 4, and the cams 6012, to achieve a tightening or loosening effect.

Further, a rotation angle of the clamping handle 6 can be 0 to 90 degrees, thus generating a clamping force of 20 to 50 N.

In one embodiment, one clamping member is provided. Correspondingly, one sliding rail 3 is provided.

In one embodiment, two clamping members are provided, and correspondingly, two sliding rails 3 are provided. Therefore, a distance between the clamping members is adjustable. This can effectively avoid the position of a makeup mirror. Furthermore, the sun visor extender can be applied to more vehicle models. In addition, compared with a solution only including one clamping member, this solution provides a more stable clamping effect.

It can be understood that three or more clamping members are provided, and correspondingly, three or more sliding rails 3 are provided.

### Mounting Mode

Based on conditions of a factory-fitted sun visor of an automobile that is driven, the clamping handle 6 is opened to adjust the position of the clamping member until a mirror piece is not blocked. The clamping handle 6 is moved to cause the cams 6012 to drive the vertical portion 505 of the T-shaped structure 5. The vertical portion 505 then drives the horizontal portion 506 to reduce a gap between the horizontal portion 506 and the T-shaped slot inner surface 306 to achieve clamping. The clip body 7015 of the elastic clip 7 is opened, and the in-vehicle sun visor extender is mounted on the factory-fitted sun visor.

### Use Mode

After the mounting of the in-vehicle sun visor extender is completed, when the extender needs to be used, the sun shading sheet 1 is pushed to cause the in-vehicle sun visor extender to rotate by using the rotating shaft 4010 as a center. When a flat surface of the sun shading sheet 1 is perpendicular to the line of sight of a user, it reaches an optimal use angle.

In addition, the optimal use effect can be achieved by adjusting the angle of the factory-fitted sun visor and the angle of the in-vehicle sun visor extender based on a body height of the user and a height of the automobile.

### Close Mode

After use, the sun shading sheet 1 is pushed away from the sun shading sheet edge 102, so that the in-vehicle sun visor extender rotates by using the rotating shaft 4010 as a center. When the in-vehicle sun visor extender is parallel to a flat surface of the factory-fitted sun visor, the in-vehicle sun visor extender nearly overlaps a bottom or a top of the factory-fitted sun visor, thereby reaching a closed state.

What is claimed is:

1. An in-vehicle sun visor extender, comprising a sun shading sheet, a bracket main body, and a clamping member slidably connected to the bracket main body, wherein
the clamping member comprises a rotating shaft assembly and a locking member; the locking member is able to lock a relative position between the bracket main body and the clamping member; and
the sun shading sheet is fixedly connected to the bracket main body.

2. The in-vehicle sun visor extender according to claim 1, wherein the bracket main body comprises a sliding rail, and the clamping member is slidably connected to the bracket main body through the sliding rail.

3. The in-vehicle sun visor extender according to claim 2, wherein a cross section of the sliding rail is substantially C-shaped; the locking member comprises a T-shaped structure; the T-shaped structure comprises a horizontal portion and a vertical portion; and the locking member is slidably connected to the sliding rail through the horizontal portion.

4. The in-vehicle sun visor extender according to claim 3, wherein the locking member further comprises a clamping handle, and the clamping member is rotatably connected to the clamping handle through the vertical portion.

5. The in-vehicle sun visor extender according to claim 4, wherein the rotating shaft assembly comprises a fitting portion, a rotating shaft, and a connection portion; the fitting portion is rotatably connected to the connection portion through the rotating shaft; the fitting portion is provided with an opening; and the vertical portion passes through the opening and is rotatably connected to the clamping handle.

6. The in-vehicle sun visor extender according to claim 5, wherein the fitting portion is fitted with a surface of the sliding rail.

7. The in-vehicle sun visor extender according to claim 5, wherein the clamping member further comprises an elastic clip, and the elastic clip is fixedly connected to the connection portion.

8. The in-vehicle sun visor extender according to claim 4, wherein the clamping handle comprises a plurality of cams arranged in sequence, and heights of the plurality of cams are different.

9. The in-vehicle sun visor extender according to claim 1, wherein one or more clamping members are provided.

10. The in-vehicle sun visor extender according to claim 9, wherein one or more sliding rails are provided.
